(19) United States
(12) Patent Application Publication
(10) Pub. No.: US 2022/0242457 A1
(43) Pub. Date: Aug. 4, 2022

(54) METHODS AND APPARATUS FOR CHARACTERIZING ROAD SURFACES

(71) Applicant: Nuro, Inc., Mountain View, CA (US)

(72) Inventor: Daniel Jason RATNER, San Francisco, CA (US)

(73) Assignee: Nuro, Inc., Mountain View, CA (US)

(21) Appl. No.: 17/568,988

(22) Filed: Jan. 5, 2022

Related U.S. Application Data
(60) Provisional application No. 63/145,202, filed on Feb. 3, 2021.

(51) Int. Cl. B60W 60/00; B60W 40/06; B60R 21/013

(52) U.S. Cl. CPC B60W 60/00184; B60W 40/06; B60R 2021/01252; B60W 2555/20; B60R 21/013

(57) ABSTRACT

According to one aspect, a method includes determining that a rapid deceleration mechanism of a vehicle is to be deployed at a first location, and identifying at least one deployment parameter associated with a deployment of the rapid deceleration mechanism, the at least one deployment parameter being associated with the first location. The method also includes deploying the rapid deceleration mechanism at the first location based on the at least one deployment parameter.

### PRIORITY CLAIM

This patent application claims the benefit of priority under 35 U.S.C. § 119 to U.S. Provisional Patent Application No. 63/145,202, filed Feb. 3, 2021, and entitled “METHODS AND APPARATUS FOR CHARACTERIZING ROAD SURFACES,” which is incorporated herein by reference in its entirety.

### TECHNICAL FIELD

The disclosure relates generally to autonomous vehicles. More particularly, the disclosure relates to systems and method for improving systems that allow for the rapid deceleration an autonomous vehicle.

### BACKGROUND

As vehicles drive, autonomously or under the control of an operator or driver, there are many instances in which vehicles in motion need to stop as quickly as possible. For example, when a pedestrian crosses a roadway directly in a path of a vehicle, the vehicle generally must either take evasive measures or come to a fast stop to avoid striking the pedestrian. In many instances, it may not be possible for a vehicle to swerve or to stop fast enough to avoid a collision.

The ability to come to a fast stop, or to decelerate rapidly, is crucial to allow vehicles to avoid collisions. Known solutions which decelerate a vehicle include Torricelli brakes, air brakes, hydraulic brakes, and pneumatic brakes. Such brakes, while generally allowing vehicles to brake, are inadequate to provide rapid deceleration due to significant frictional forces that arise when the brakes are engaged.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a diagrammatic representation of a side view of a vehicle with a rapid deceleration mechanism, in a deployed state, in accordance with an embodiment.

FIG. 5A is a block diagram representation of a test vehicle which may gather road characterization data for use by a rapid deceleration mechanism in accordance with an embodiment.

FIG. 5B is a block diagram representation of an anchor/road testing system, e.g., anchor/road testing system 560 of FIG. 5A, in accordance with an embodiment.

FIG. 6 is a process flow diagram which illustrates a method of using a test vehicle to collect data for use by a simulation system in accordance with an embodiment.

FIG. 7 is a block diagram representation of a rapid deceleration system, e.g., rapid deceleration system 350 of FIG. 3, in accordance with an embodiment.

FIG. 8 is a diagrammatic representation of a system in which a test vehicle collects data which is used by a simulation system to create configuration files for use by an autonomous vehicle with a rapid deceleration mechanism in accordance with an embodiment.

FIG. 9 is a process flow diagram which illustrates a method of operating an autonomous vehicle which includes a rapid deceleration mechanism in accordance with an embodiment.

FIG. 10 is a process flow diagram which illustrates a method of obtaining data relating to a road surface, e.g., step 613 of FIG. 6, in accordance with an embodiment.

FIG. 11 is a block diagram representation of a road characterization sensor arrangement, e.g., road characterization sensor arrangement 558c of FIG. 5A, in accordance with an embodiment.

FIG. 12 is a diagrammatic representation of a first process, over time, of obtaining and utilizing road characterization data in accordance with an embodiment.

FIG. 13 is a diagrammatic representation of a first process, over time, of obtaining and utilizing road characterization data in accordance with an embodiment.

### DESCRIPTION OF EXAMPLE EMBODIMENTS

### General Overview

According to one embodiment, a method includes determining that a rapid deceleration mechanism of a vehicle is to be deployed at a first location, and identifying at least one deployment parameter associated with a deployment of the rapid deceleration mechanism, the at least one deployment parameter being associated with the first location. The method also includes deploying the rapid deceleration mechanism at the first location based on the at least one deployment parameter. In such an embodiment, the at least one deployment parameter may include at least one selected from a group including a deployment force and a deployment pressure.

In another embodiment, a vehicle includes a chassis and a rapid deceleration system carried on the chassis. The rapid deceleration system is configured to deploy an anchor to anchor or otherwise substantially secure the vehicle to a road surface. The rapid deceleration system is further configured to deploy the anchor at a first location based on at least one deployment parameter, the at least one deployment parameter including at least one selected from a group including a deployment force and a deployment pressure.

In still another embodiment, a platform includes a first vehicle and an apparatus. The first vehicle includes a chassis and a rapid deceleration system carried on the chassis. The rapid deceleration system including an anchor, and the rapid deceleration system is configured to deploy the anchor to anchor the first vehicle to a road surface. The rapid deceleration system is further configured to deploy the anchor at a first location based on at least one deployment parameter, the at least one deployment parameter including at least one selected from a group including a deployment force and a deployment pressure. The apparatus includes a simulation system, the simulation system configured to determine at least one of the deployment force and the deployment pressure associated with the first location.

A system for rapidly decelerating a vehicle that includes one or more anchors may be arranged to utilize information relating to a road surface to determine parameters associated with deploying the one or more anchors. Road surfaces may be characterized, and the characteristics of the road surfaces may be used with simulation models which determine deployment parameters for anchors. Output from the simulation models may be provided to a vehicle with a rapid deceleration system such that when the vehicle deploys one or more anchors, the vehicle may deploy the one or more anchors using deployment parameters which facilitate an efficient and robust deployment. When a simulation model is used to determine deployment parameters associated with a particular location on a road, the parameters may be provided to a rapid deceleration system such that the parameters may be used when an anchor is to be deployed at that particular location.

### Description

While braking systems on a vehicle such as an autonomous vehicle may serve to provide adequate deceleration and braking in most situations, some situations may arise in which rapid deceleration that may not be accomplished using braking systems may be needed. For example, if a vehicle is travelling or driving and an obstacle such as a pedestrian suddenly appears directly in front of the vehicle, the use of braking systems may not be adequate to prevent the vehicle from colliding with the obstacle.

By providing a rapid deceleration system of mechanism for use when a braking system on a vehicle is expected to be inadequate to prevent a vehicle from a collision, the chances of averting a collision may be increased. Such a rapid deceleration system may be arranged as a “last chance” braking system that may be activated to cause the vehicle to come to a stop when conditions indicate that a primary braking system may be insufficient. Such conditions may include, but are not limited to including, a speed at which the vehicle is travelling, a current distance between the vehicle and an anticipated location of a collision with an Obstacle, and/or a speed at which an obstacle is travelling.

In one embodiment, if a collision is considered to be imminent and it is determined that the collision may not be avoided by if a primary braking system of an autonomous vehicle is used to decelerate the autonomous vehicle, then a rapid deceleration system may be activated or engaged. The rapid deceleration system may, when activated, effectively anchor a vehicle to a surface on which the vehicle is travelling. The rapid deceleration system may be arranged to alter, e.g., damage, a surface on which the vehicle is travelling in order to substantially ensure that a collision is avoided. The rapid deceleration system of a vehicle may include an anchor or a ram which is arranged to be deployed into a road or other surface such that the anchor causes the vehicle to be anchored to the road or other surface.

A system for rapidly decelerating a vehicle may include at least one powered driver and at least one anchor supported by the powered driver. The powered driver may be arranged to be to be movably coupled to a frame or a chassis of the vehicle. The powered driver may also be configured to propel the anchor from the powered driver into a road surface to both secure the vehicle to the road surface and to absorb energy through substantially deforming the anchor and the vehicle chassis or frame. The use of a powered driver to effectively drive or force an anchor into a surface such as a road surface allows a vehicle to decelerate.

Road variability, or differences in different road surfaces, may have an effect on how an anchor of a rapid deceleration system is deployed. By characterizing roads, e.g., road surfaces, and using road characterization data from a road characterization process in a simulation model or system, deployment parameters for the rapid deceleration system to use when deploying an anchor may effectively be tailored to a road surface type. The simulation model or system may calculate or otherwise determine energies that are effectively needed to fire an anchor of a rapid deceleration system into a given road to arrive at a substantially desirable interface between the anchor and the road, e.g., an anchor/road joint. When characteristics of a road surface are known, a vehicle such as an autonomous delivery vehicle with a rapid deceleration system may use an appropriate amount of energy to deploy an anchor into a road. In one embodiment, when the simulation model or system uses characteristics of an actual location on a road to determine parameters for use to deploy an anchor into that location, the parameters may be used by a rapid deceleration system to effectively specify parameters to use to deploy the anchor at that location.

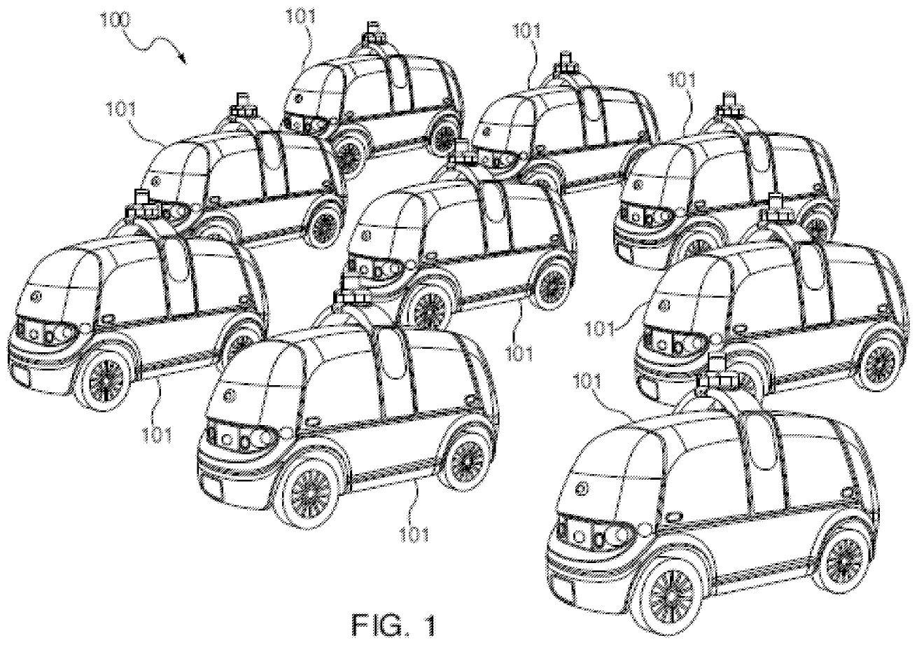

Many autonomous vehicles operate as part of a fleet of autonomous vehicles. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

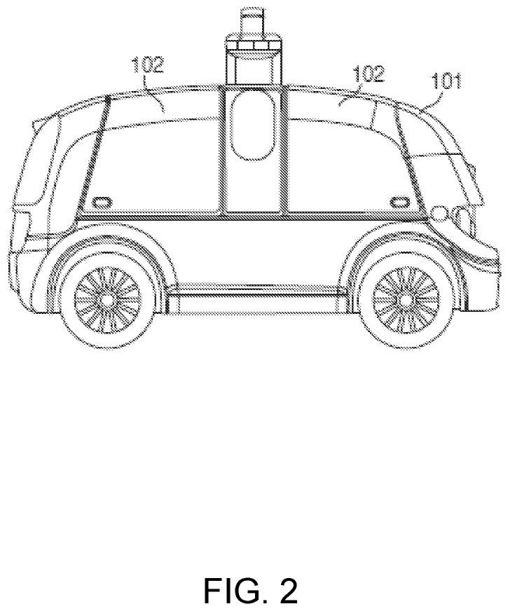

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

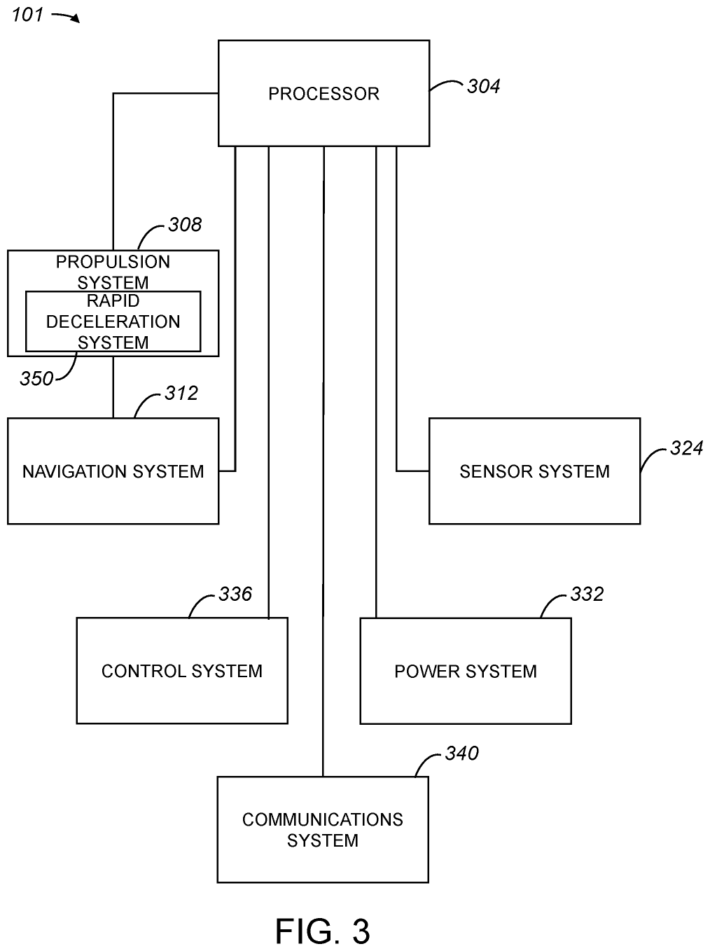

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

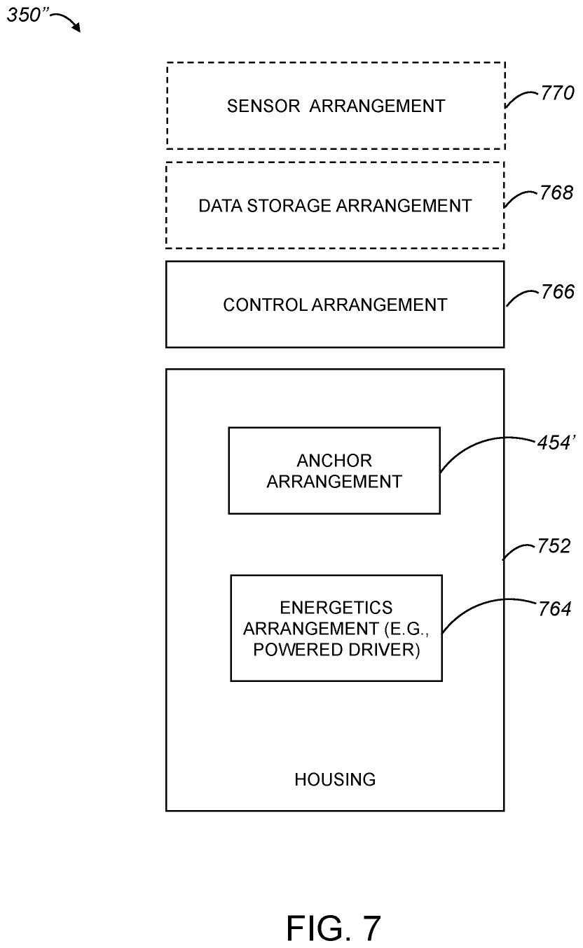

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine. Propulsion system 308 includes a rapid deceleration system 350 that may be configured to facilitate the rapid deceleration of vehicle 101, e.g., when braking systems are not sufficient to cause vehicle 101 to rapidly decelerate. In one embodiment, rapid deceleration system 350 includes one or more anchors that are powered by a powered driver that propels the one or more anchors from the powered driver into a road surface. Rapid deceleration system or mechanism 350 will be discussed below with respect to FIG. 7. The force with which a power driver propels an anchor into a road surface may be dependent upon characteristics of the road surface. Rapid deceleration system 350 also include software logic which enables a suitable deployment force and/or pressure applied by the power driver to be identified or otherwise determined.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communication module 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

The ability to rapidly decelerate a vehicle such as autonomous vehicle 101 enhances the ability of the vehicle to operate safely by increasing the likelihood that the vehicle may avoid collisions, e.g., by rapidly slowing to a stop in a relatively fast manner. When it is determined that a primary or “normal” braking system is unlikely to be sufficient to avoid an obstacle located along an immediate path a vehicle, a secondary or “emergency” deceleration system may be activated. Such a deceleration system may be arranged to rapidly decelerate by deploying a mechanism that cuts into a surface, e.g., a pavement or a surface of a roadway, to effectively anchor the vehicle to the surface.

As road surfaces may differ, the amount of force used to propel an anchor into a road surface may be determined based on characteristics of the road surface. For example, the composition of the road surface, the thickness of the road surface, and/or the temperature of the road surface may have an effect on an amount of force or anchor firing energy to use to propel an anchor into the road surface. Some roads may have more asphalt than concrete, and some roads may have different top layer thicknesses, e.g., some roads may have a top layer with a thickness of approximately three inches while some roads may have a top layer with a thickness of up to approximately twelve inches. Further, some road surfaces may be relatively hot and soft, while other road surfaces may relatively cold and hard. By characterizing a road surface and providing a characterization of the road surface to a vehicle with a rapid deceleration mechanism, the vehicle may determine how much force to use to deploy an anchor based at least in part upon the characteristics of the road surface.

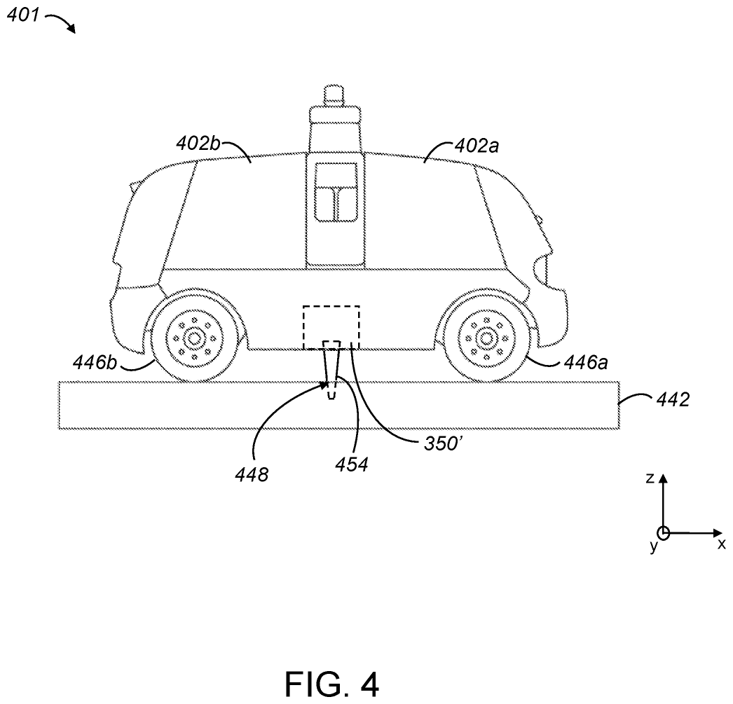

FIG. 4 is a diagrammatic representation of a side view of a vehicle with a rapid deceleration mechanism, in a deployed state, in accordance with an embodiment. An autonomous vehicle 401, which may include components and features of autonomous vehicle 101 of FIGS. 2 and 3, is generally arranged to drive or be otherwise conveyed on a surface 542. Surface 442 may be a surface of a road, and may be a pavement surface formed from a material such as concrete or asphalt, or a mixture of concrete and asphalt.

Rapid deceleration system or mechanism 350′ is mounted on autonomous vehicle 501. As shown, rapid deceleration mechanism 350′ is mounted on a bottom side or surface of autonomous vehicle 401 such that an anchor 454 may be deployed into surface 442. In general, rapid deceleration mechanism 350′ may be positioned between front wheel 446a and back wheel 446b relative to an x-axis, although it should be appreciated that rapid deceleration mechanism is not limited to being positioned between front wheel 446a and back wheel 446b.

Rapid deceleration mechanism 350′ is positioned substantially over surface 442, and is arranged to allow autonomous vehicle 401 to rapidly decelerate when rapid deceleration mechanism 450′ is deployed. For example, if autonomous vehicle 401 is travelling in a direction along the x-axis when anchor 454 of rapid deceleration mechanism 350′ is deployed, autonomous vehicle 401 may decelerate or otherwise slow as autonomous vehicle 401 travels in a direction along the x-axis. An anchor/road joint 448 is substantially formed when anchor 454 is deployed into surface 442.

In one embodiment, rapid deceleration mechanism 350′ may be provided with data which allows for anchor 454 to be deployed with a firing energy that is determined based on characteristics of road surface 442. For example, a test vehicle may collect road characterization data such as materials from which a road surface is formed, a thickness of the road surface, etc. The test vehicle may also effectively use geolocation to identify a location of the road surface for which road characterization data is collected. The data or information collected by the test vehicle may be provided to a simulation system or model which uses the data to determine a firing energy or force for one or more anchors that would enable a relatively strong, robust anchor/road joint to be formed. Once the firing energy or force, or pressure, is determined, an indication of the firing energy may be provided to rapid deceleration mechanism 350′. It should be appreciated that rapid deceleration mechanism 350′ may include hardware and/or software devices configured to process information relating to firing energies and to cause an anchor to be deployed using that firing energy, or an appropriate deployment force and/or pressure.

A simulation system may use information collected from a test vehicle, as well as information from other sources, e.g., information from a public works department, to determine an appropriate firing energy to use to deploy an anchor into the particular road surface. The information from a public works department, or county records, which may include, but is not limited to including, the composition of a particular road surface at a particular location and/or an age of the road surface. The simulation system may also inform a decision of a material from which an anchor is to be formed and/or a size and shape of the anchor.

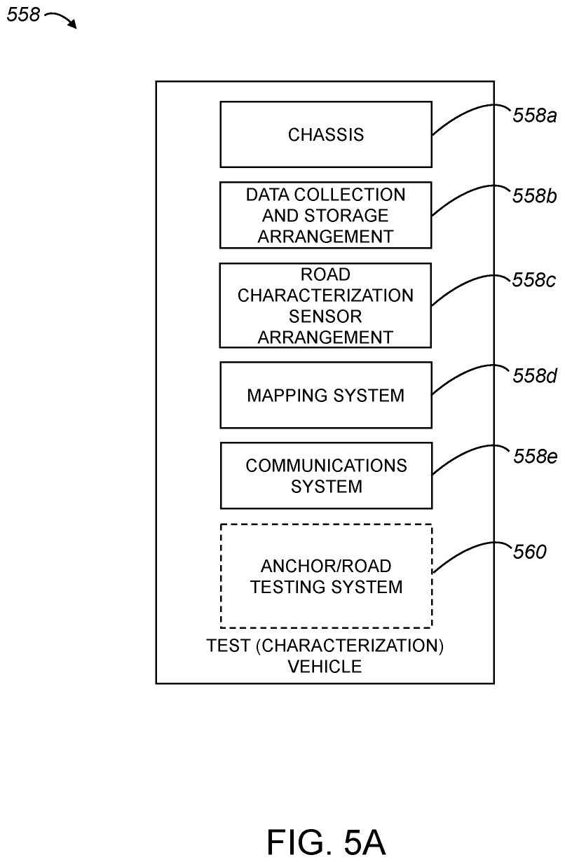

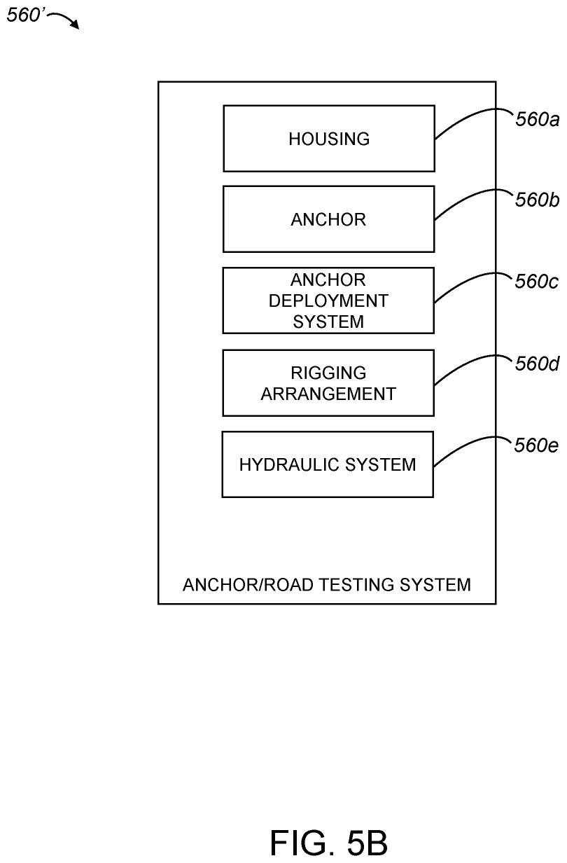

FIG. 5A is a block diagram representation of a test vehicle which may gather road characterization data for use by a rapid deceleration mechanism in accordance with an embodiment. A test vehicle 558, which may be any suitable vehicle capable of driving on roads, includes a chassis or frame 558a. A data collection and storage arrangement 558b, a road characterization sensor arrangement 448c, a mapping system 558d, a communications system 558e, and an optional anchor/road testing system 560 may be supported on, or otherwise supported by, chassis 558a. It should be appreciated that test vehicle 558 includes systems which are not shown for ease of illustrations. Such systems include, but are not limited to including, at least a propulsion system and a power system.

Test vehicle 558 is generally arranged to collect data while travelling on roads. Data collection and storage arrangement 558b stores data collected by test vehicle 558, e.g., data collected by road characterization sensor arrangement 558b and mapping system 558d. Data collection and storage arrangement 558b may generally include a database that is in communication with road characterization sensor arrangement 558c, mapping system 558d, and communications system 558e.

Road characterization sensor arrangement 558c is configured to include one or more sensors which collect information associated with a road surface and conditions in the environment around the road surface. In one embodiment, sensors include, but are not limited to including, a ground penetrating radar, a thermometer, a metal detector, an infrared (IR) camera, and/or other sensor types.

Mapping system 558d enables a location of test vehicle 558 to be located, e.g., through geolocation. It should be appreciated that mapping system 558d may generally collect data from sensors on test vehicle 558 including, but not limited to including, cameras, lidars, and/or radars. Using the collected data, mapping system 558d may effectively create maps which may be used by an autonomous vehicle to navigate. Maps created may include, but are not limited to including, autonomy maps.

Communications system 558e may enable information collected and stored by data collection and storage arrangement 558b to be provided to a server, e.g., a server of a fleet management system or an enterprise which dispatches test vehicle 558. Communications system 558e may also, in some embodiments, enable test vehicle 558 to provide information substantially directly to a simulation system which may use the information to run simulations relating to the deployment of anchors of a rapid deceleration system. Communications system 558e may include ports which support wired and/or wireless communications including, but not limited to including, Wi-Fi communications, LTE communications, and/or 3G/4G/5G communications.

In one embodiment, test vehicle 558 may include an optional anchor/road testing system 560. When test vehicle 558 includes optional anchor/road testing system 560, test vehicle 558 may perform actual tests relating to how much firing power is appropriate to deploy anchors of given sizes and/or configurations into a particular road surface. With reference to FIG. 5B, one embodiment of optional anchor/road testing system 560 will be described. Anchor/road testing system 560′, which may be optional, is generally arranged at least partially on test vehicle 558. For example, anchor/road testing system 560′ may be coupled to test vehicle 558 such that anchor/road testing system 560′ is supported by test vehicle 558 while configured to deploy an anchor into a road surface.

Anchor/road testing system 560′ may include a housing 560a, an anchor 560b, an anchor deployment system 560c, a rigging arrangement 560d, and a hydraulic system 560e. Housing 560a may be a mechanical structure configured to support at least anchor deployment system 560c.

Anchor 560b may be an anchor or a spike configured to be deployed into a road surface. Anchor deployment system 560c may include energetics that enable anchor 560b to be deployed into a road surface. In one embodiment, anchor deployment system 560c may be configured as a nail gun, e.g., a powder actuated nail gun, and anchor 560b may be similar in configuration to a nail that is arranged to be deployed by the nail gun.

Rigging arrangement 560d may be configured such that when anchor 560b is deployed, anchor 560b is deployed by anchor deployment system 560c through rigging arrangement 560d. By way of example, rigging arrangement 560d may include an opening through which anchor 560d is deployed into a road surface, and a rigging D-ring which may be engaged by hydraulic system 560e to substantially apply forces to anchor 560d after deployment into the road surface. Hydraulic system 560e may pull at anchor 560d from different pull angles, e.g., angles of between approximately zero degrees and approximately ninety degrees. Hydraulic system 560e may include a scale that may effectively measure the pull forces exerted on anchor 560d, and may also be used to pull anchor 560b out of a road surface after deployment.

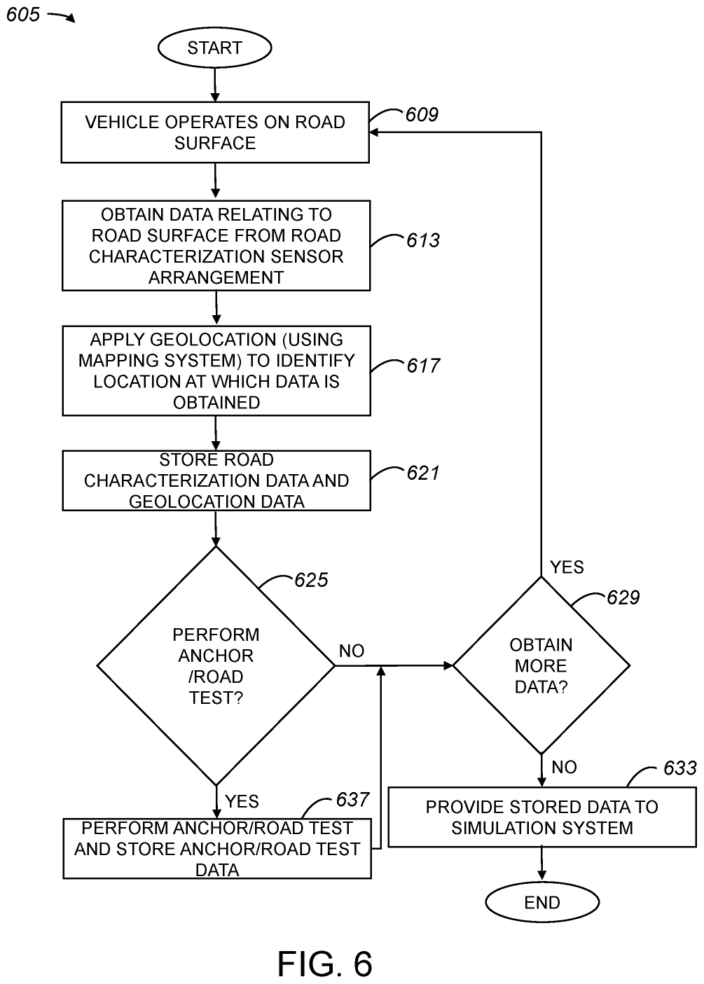

As previously mentioned, a test vehicle such as test vehicle 558 may collect road characterization data which may be used by a simulation system to simulate road conditions and anchor deployment conditions. FIG. 6 is a process flow diagram which illustrates a method of using a test vehicle to collect data for use by a simulation system in accordance with an embodiment. A method 605 of using a test vehicle to collect data for use by a simulation system begins at a step 609 in which a test vehicle operates on a road surface. As the vehicle operates, the vehicle collects or otherwise obtains data relating to the road surface from a road characterization sensor arrangement in a step 613.

In a step 617, geolocation is applied, as for example using a mapping system onboard the vehicle, to identify a location from which data is obtained. That is, geolocation is used to substantially associate data collected by a road characterization sensor arrangement with a real-world location. Once geolocation is effectively applied to data collected by a road characterization sensor, the road characterization data and the geolocation data are stored in a step 621.

After data is stored, a determination is made in a step 625 as to whether an anchor/road test is to be performed. That is, it is determined whether a vehicle includes an anchor/road testing system such as system 560 of FIG. 5A and, if so, whether the anchor/road testing system is to be used. Such a determination may be based upon factors including, but not limited to including, whether a particular road surface has previously been tested and/or whether a road surface in a particular area of a city has been tested.

If the determination is that an anchor/road test is not to be performed, process flow proceeds to a step 629 in which it is determined whether more data is to be obtained. If it is determined in step 629 that more data is to be obtained, process flow returns to step 609 in which the vehicle continues to operate on the road surface. Alternatively, if it is determined that additional data is not to be collected or otherwise obtained, the stored data is provided to a simulation system in a step 633, and the method of using a test vehicle to collect data for use by a simulation system is completed.

Returning to step 625 and the determination of whether to perform an anchor/road test, if it is determined that an anchor/road test is to be performed, then the anchor/road test is performed in a step 637. Once the anchor/road test is performed, and data collected or otherwise obtained during the anchor/road test is stored, process flow proceeds to step 629 in which it is determined whether more data, e.g., data relating to the road surface, is to be obtained.

Road characterization data is generally provided to a simulation system in order to determine appropriate parameters to use when firing one or more anchors of a rapid deceleration system that is included on an autonomous vehicle. FIG. 7 is a block diagram representation of a rapid deceleration system, e.g., rapid deceleration system 350 of FIG. 3, in accordance with an embodiment. Rapid deceleration system 350″ includes at least one housing 752 that is arranged to be positioned on or otherwise supported on a vehicle such as vehicle 101 of FIGS. 2 and 3. Housing 752 includes an anchor arrangement 454′ and an energetics arrangement such as a powered driver 764.

Anchor arrangement 454′ may include at least one anchor that is configured to be deployed by energetics arrangement 764, which applies an anchor firing energy to cause the anchor to be propelled into a surface such as a road surface. The amount of energy used to cause the anchor to be propelled into a surface may depend upon the characteristics of the surface, and may be determined at least in part by a simulations system. When an anchor of anchor arrangement 454′ is deployed, the anchor may effectively cut into a surface on which a vehicle such as vehicle 101 of FIGS. 2 and 3 is travelling or driving.

Energetics arrangement 764 which may be an actuating mechanism or a powered driver, is configured to deploy an anchor of anchor arrangement 454′, as for example towards a road surface to cut into the road surface. Energetics arrangements 764 may include, but is not limited to including, pyrotechnic telescoping devices or other mechanisms which may be selectively activated to cause an anchors of anchor arrangement 454′ to be propelled towards the road surface.

Rapid deceleration system 350″ also includes a control arrangement 766, and may optionally include a data storage arrangement 768 and a sensor arrangement 770. Control arrangement 766 may include a communications system, and/or may be coupled to a communications system of a vehicle which includes rapid deceleration system 350″. Control arrangement 766 may be arranged to control energetics arrangement 764 such that energetics arrangement 764 provides a suitable firing energy given a particular road surface. In one embodiment, there may be a default firing energy provided when characteristics of a road surface are unknown.

Control arrangement 766 may be configured to receive or to otherwise obtain configuration (config) files from a simulation system. The config files may generally provide parameters, e.g., rapid deployment parameters, which may allow control arrangement 766 to adjust firing parameters associated with energetics arrangement 764. For example, values output from a simulation model or system may be provided to control arrangement 766 in config files which may be used to enable control arrangement 766 to substantially track a location and to effectively match an anchor firing energy to a target road into which an anchor of anchor arrangement 454′ is to be deployed at a given time and place.

Optional data storage arrangement 768 is configured to store data, e.g., config files obtained from a simulation model or system. Data stored in optional data storage arrangement 768 may be updated periodically, and may be accessed by control arrangement 766. In one embodiment, config files may be provided to optional data storage arrangement 768 as an autonomous vehicle that includes rapid deceleration system 350″ is driving such that control arrangement 766 may effectively have access to the most updated data available.

Optional sensor arrangement 770 may include any suitable sensors which may provide information which may be used by control arrangement 766 to substantially control energetics arrangement 764. By way of example, optional sensor arrangement 770 may include at least one temperature sensor which allows a current temperature of a road surface to be determined. Data regarding the current temperature of a road surface may enable control arrangement 766 to select suitable parameters for energetics arrangement 764, e.g., a hot road surface may have a different suitable anchor firing energy than a cold road surface. The temperature of the road surface may vary depending upon a current season, a time of day, and/or an amount or intensity of sunlight on the road surface. For example, a road surface may be hotter during summer months in the northern hemisphere, during daylight hours, and/or when there is direct sunlight essentially beating on the road surface.

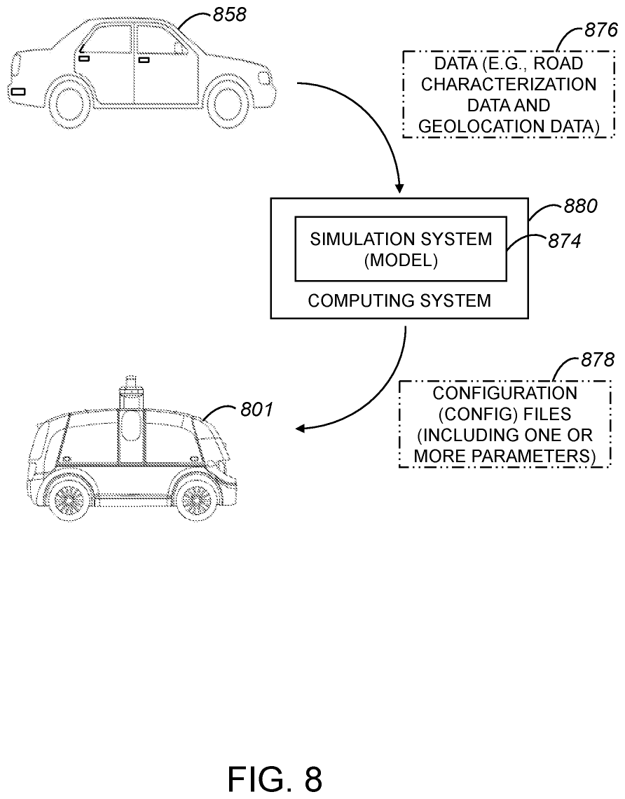

With reference to FIG. 8, a system in which a test vehicle collects data which is used by a simulation system to create configuration files for use by an autonomous vehicle with a rapid deceleration mechanism will be described in accordance with an embodiment. A system or a platform includes a test vehicle 858 and an autonomous or semi-autonomous vehicle 801. Test vehicle 858, which may be any suitable vehicle, generally includes a data collection and storage arrangement, a road characterization sensor arrangement, and a mapping system. In general, test vehicle 858 includes systems discussed above with respect to test vehicle 558 of FIG. 5A.

Test vehicle 858 collects or otherwise obtains data 876. Data 876 collected by test vehicle 858 may include, but is not limited to including, road characterization data and geolocation data. Data 876 is provided to a simulation system 874 for processing. Simulation system 874 may be part of the platform that includes vehicles 801, 858. Simulation system 874 may use data 876, as well as other data such as data obtained from records, e.g., county records, to simulate road conditions at various locations at which an anchor of a rapid deceleration system may be deployed. Simulation system 874 may be used to simulate deployment of different types of anchors and/or anchor firing energies with respect to various types of road characteristics. Through simulation, simulation system 874 may determine a set of parameters which may be suitable for particular road characteristics and/or for particular actual road locations. Such parameters may be stored in config files 878. In one embodiment, simulation system 874 may use road characterization data, geolocation data, data obtained from records, and data obtained from an anchor/road test system to generate config files 878.

Simulation system 874, as shown, executes on a computing system 880 which is remote with respect to test vehicle 858. It should be appreciated, however, that simulation system 874 may instead be onboard test vehicle 858, or distributed between computing system 880 and test vehicle 858. Simulation system 874 may be embodied as hardware and/or software code devices which may be executed by one or more processors included in computing system 880.

The parameters identified by simulation system 874 may generally identify anchor firing energies as mentioned above. For example, a road surface that is formed from asphalt may have different characteristics than a road surface that is formed from concrete, as concrete is generally more durable than asphalt. As such, the anchor firing energies associated with enabling an anchor to penetrate a road surface and effectively anchor vehicle 801 to the road surface may differ for different road surfaces. The anchor firing energies may also vary depending upon the temperature of the road surface, the density of the road surface, the thickness or depth associated with the road surface, and/or whether the road surface is moist or dry.

In one embodiment, parameters may be such that a higher force or pressure is specified for the deployment of an anchor into concrete than for the deployment of an anchor into asphalt. For example, a pressure of between approximately 2800 pounds per square inch (psi) and approximately 3000 psi may be appropriate for the deployment of an anchor into concrete, while a lower pressure of approximately 1000 psi may be appropriate for the deployment of an anchor into asphalt. In generally, a pressure in a range of between approximately 1000 psi and approximately 6000 psi may be suitable for the deployment of an anchor into a road surface. As will be appreciated by those skilled in the art, a pressure is generally a force per unit area, or a quantity of force effectively spread out over an area.

Parameters may be such that when a road surface is heated up, as for example by sunlight or during summer months, deployment parameters may differ from parameters associated with a colder road surface. As mentioned above, the temperature of a road surface may have an effect on deployment parameters, and the temperature of the road surface may vary depending upon a season, a time of day, and an amount of sunlight shining on the road surface. By way of example, a road surface may be relatively compliant or flexible when hotter, and relatively brittle when colder. A road surface may be formed from asphalt cement, which may effectively hold a hot mix asphalt (HMA) pavement together. Such a road surface may be relatively viscoelastic, and may exhibit both viscous and elastic characteristics. It should be appreciated that characteristics may vary based upon factors including, but not limited to including, the temperature of a road surface. At a higher temperature, asphalt cement may have more fluid-like characteristics while, at lower temperature, the asphalt cement may have more solid characteristics.

Config files 878 are provided to vehicle 801, which may be an autonomous vehicle which includes a rapid deceleration system such as rapid deceleration system 350″ of FIG. 7. Vehicle 801 may use config files 878 to obtain parameters for use when an anchor of a rapid deceleration system is to be fired or otherwise deployed. It should be appreciated that there may be more than one config file 878 associated with a road location, e.g., different config files for different temperatures, or there may be a substantially single config file 878 associated with the road location, e.g., when the config file specifies different deployment parameters for different temperatures. That is, each config file 878 may include specifications for different deployment parameters associated with a particular road location.

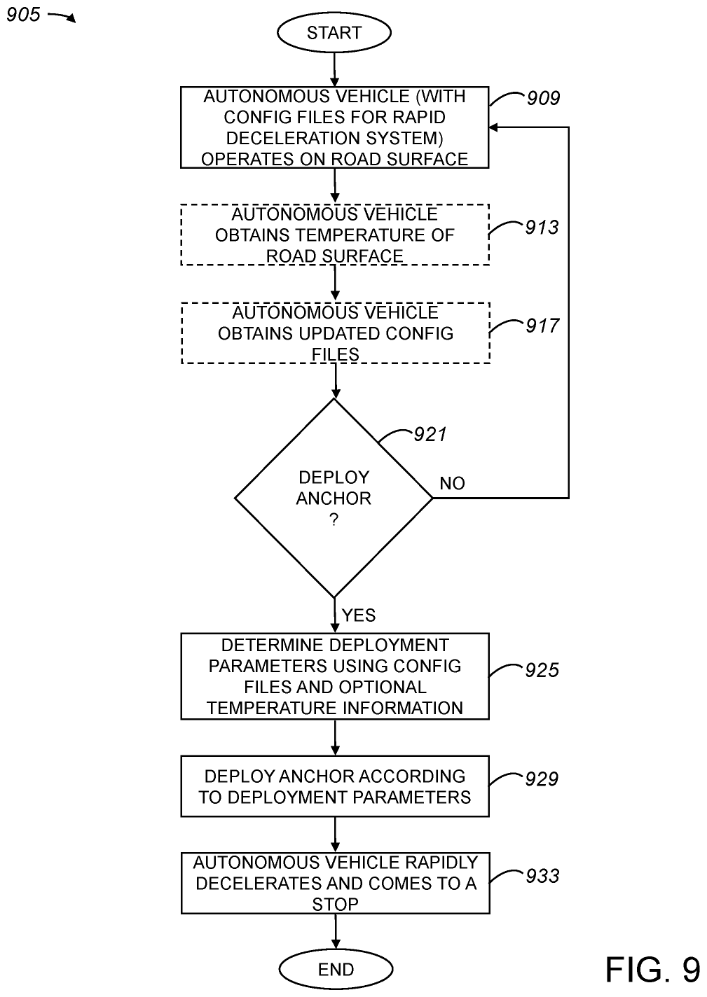

FIG. 9 is a process flow diagram which illustrates a method of operating an autonomous vehicle which includes a rapid deceleration mechanism in accordance with an embodiment. A method 905 of operating an autonomous vehicle which includes a rapid deceleration mechanism begins at a step 909 in which an autonomous vehicle, which has config files to be used by a rapid decelerations system on the autonomous vehicle, operates on a road surface. In an optional step 913, the autonomous vehicle may obtain a temperature of the road surface, and in an optional step 917, the autonomous vehicle may obtain updated config files as updated config files become available.

From step 909, and/or from optional steps 913 and 917, process flow proceeds to a step 921 in which it is determined whether an anchor is to be deployed. That is, a determination is made as to whether a rapid deceleration system is to be engaged.

If the determination in step 921 is that an anchor is not to be deployed, process flow returns to step 909 in which the autonomous vehicle continues to operate on the road surface. Alternatively, if it is determined that the anchor is to be deployed, then the indication is that the autonomous vehicle has encountered a situation in which rapid deceleration is either advisable or necessary. Accordingly, in a step 925, deployment parameters are determined or otherwise determined using config files and optional temperature information. The deployment parameters generally indicate parameters to use, including at least an approximate anchor deployment force or pressure, to enable an anchor to be deployed and anchored into a surface. In one embodiment, the config files may include parameters to use for a particular location on a road, as well as an indication relating to the particular location, e.g., coordinates of the particular location. In another embodiment, the config files may include parameters to use based on road characteristics, e.g., parameters to use when a road surface is of a particular type and has a particular depth.

Once deployment parameters are determined, an anchor is deployed in a step 929 according to the deployment parameters. After the anchor is deployed, the autonomous vehicle rapidly decelerates and comes to a stop in a step 933, and the method of operating an autonomous vehicle which includes a rapid deceleration mechanism is completed.

As mentioned above, a test vehicle, or a vehicle that is configured to obtain or otherwise collect road characterization data, is substantially outfitted with onboard sensors arranged to collect road characterization data. In one embodiment, the onboard sensors or a road characterization sensor arrangement are substantially dedicated to collecting road characterization data. It should be appreciated, however, that the road characterization sensor arrangement may include at least one sensor that is part of a different vehicle system and/or utilized for other purposes. For example, a road characterization sensor arrangement may include a camera that is part of a perception system of an autonomous vehicle.

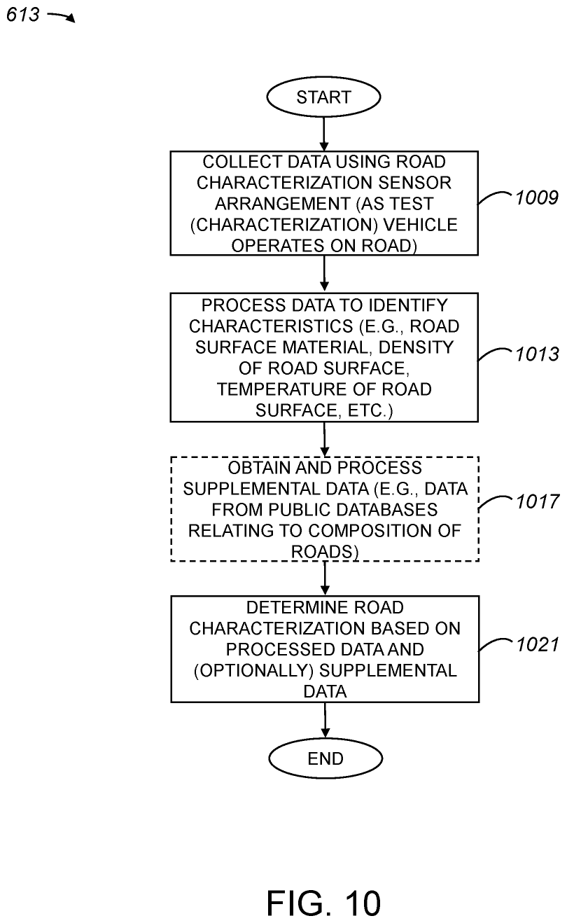

Referring next to FIG. 10, a method of obtaining data relating to a road surface using a road characterization sensor arrangement, e.g., step 613 of FIG. 6, will be described in accordance with an embodiment. Method 613 of obtaining data relating to a road surface begins at a step 1009 in which data is collected using a road characterization sensor arrangement of a test, or characterization, vehicle. The data may be collected while the test vehicle is operating on a road.

Data is processed in a step 1013 to identify characteristics. The data may be processed by a system onboard the test vehicle, or by a remote system that is in communication with the test vehicle. The characteristics may relate to qualities and/or parameters associated with a road and/or a road surface. For example, the characteristics may include, but are not limited to including, a type of material which forms the road surface, a density of the material which forms the road surface, a depth of the road surface, and/or a temperature of the road surface.

From step 1013, process flow moves to an optional step 1017 in which supplemental data may be obtained and processed. Supplemental data may include, but is not limited to including, data from public databases which may relate to the composition of roads. By way of example, a database such as a public database of county records may identify whether a particular road is formed from asphalt, concrete, a combination of asphalt and concrete, gravel, and/or dirt.

In a step 1021, a road characterization is determined based on processed data and, optionally, supplemental data. That is, characteristics of a road at a particular location are determined based on processed data and, optionally, supplemental data. Such a road characterization may include, but is not limited to including, an indication of a type of material which forms a road surface at a particular location, a density of the material at the particular location, the depth of the road surface at the particular location, and/or a temperature at the particular location at the time data was obtained. Temperature data may be used, for example, to identify the temperature of the road surface at a particular time and to extrapolate to determine the expected temperature of the road surface at different times. Upon determining the road characterization, the method of obtaining data relating to a road surface is completed.

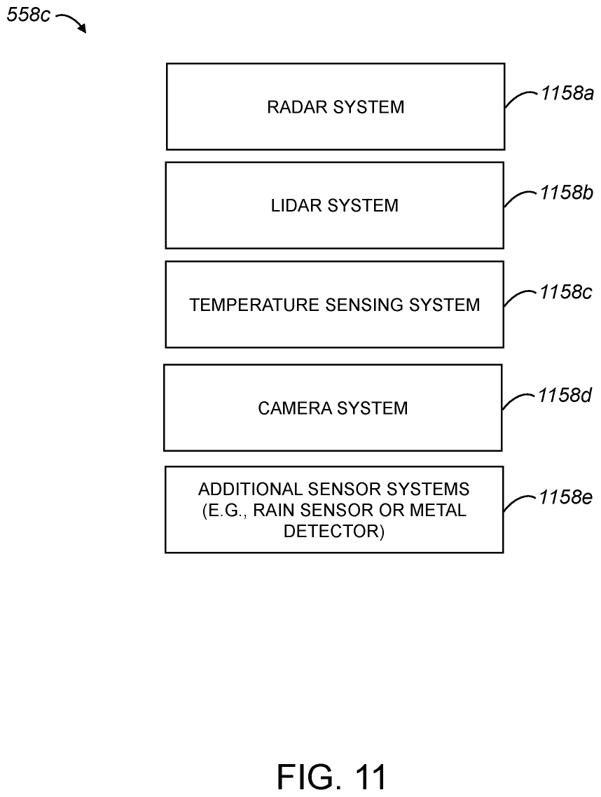

Sensors used to characterize a road may vary widely. With reference to FIG. 11, a road characterization sensor arrangement, e.g., road characterization sensor arrangement 558c of FIG. 5A, in accordance with an embodiment. Road characterization sensor arrangement 558c may generally include sensors and sensor system 1158a-e that are onboard a test vehicle and are substantially dedicated to characterizing roads. In one embodiment, road characterization sensor arrangement 558c may be mounted on an apparatus, e.g., a trailer, which is effectively towed by a test vehicle. It should be appreciated, however, that sensors or sensor systems 1158a-e may include sensors which may also be utilized by a vehicle for purposes other than road characterization.

A radar system 1158a may generally include one or more radar units. Radar units may include, but are not limited to including ground penetrating radar units configured to essentially study surfaces below a top surface. That is, one or more ground penetrating radar units may be used to substantially view a subsurface of a road. A density of the material from which a road is formed may be ascertained using one or more ground penetrating radar units.

A lidar system 1158b may include one or more lidar units configured to identify features associated with surfaces of a road. The lidar units may generally vary widely, and may use any suitable type of lidar technology.

A temperature sensing system 1158c may include any suitable temperature sensors. At least one temperature sensor included in temperature sensing system 1158c may be configured to obtain a temperature associated with a road surface. The temperature associated with a road surface may have an effect on the physical qualities associated with the road surface. By way of example, in freezing temperatures, a road surface may be more brittle that the road surface would be in relatively high temperatures. In general, temperatures may have an effect on characteristics associated with a road surface.

A camera system 1158d may include one or more cameras including, but not limited to including, at least one video camera, at least one still camera, and/or at least one infrared camera. The one or more cameras may be used to ascertain whether a road surface is wet or dry, and/or to substantially confirm what is sensed by other sensor system. For example, camera system 1158d may be used to confirm whether a road surface appears to be formed from or otherwise composed of asphalt, concrete, and/or a combination of asphalt and concrete when radar system 1158a identifies which material the road surface is formed from.

Road characterization sensor arrangement 558c may also include additional sensor system 1158e. Additional sensor systems 1158e may include, but are not limited to including, rain sensors, metal detectors, humidity sensors, and/or moisture sensors. Rain sensors may be configured to detect rain and, hence, when a road surface is wet. Metal detectors may be configured to detect metal such as railroad tracks and/or metal plates such as maintenance hole covers. Humidity sensors and/or moisture sensors may also determine whether a road surface is wet. Road features identified by additional sensor system 1158e may effectively be confirmed using camera system 1158d.

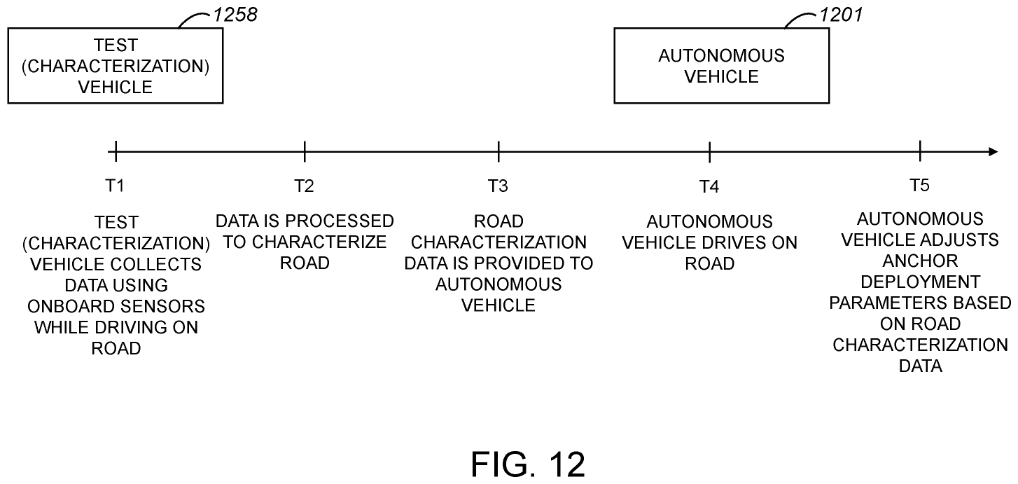

FIG. 12 is a diagrammatic representation of a process, over time, of obtaining and utilizing road characterization data in accordance with an embodiment. At a time T1, a test or characterization vehicle 1258 is drives or otherwise operating on a surface such as a road surface. While driving or otherwise operating, test vehicle 1258 collects data using onboard sensors, e.g., a road characterization sensor arrangement such as road characterization sensor arrangement 558c of FIGS. 5 and 11.

At a time T2, the data obtained by test vehicle 1258 at time T2 is processed to characterize the road. Processing the data may further include processing supplemental data, such as data obtained from databases configured to store road information. The data may be processed by a simulation system such as simulation system 874 of FIG. 8 which effectively identifies appropriate deployment forces associated with a rapid deceleration system. The data may be processed onboard test vehicle 1258, by a system that is remote with respect to test vehicle 1258, and/or by both test vehicle 1258 and a system that is remote with respect to test vehicle 1258. Processing data generally include identifying deployment parameters for anchors of a rapid deceleration system that are suitable for efficiently deploying the anchors at particular locations on a road. As mentioned above, the deployment parameters may be identified using a simulation system such as simulation system 874 of FIG. 8.

After the data is processed, the data may be provided at a time T3 to an autonomous vehicle 1201 which may use the data to determine deployment parameters to use to deploy an anchor of a rapid deceleration system. In one embodiment, determining deployment parameters may include identifying an appropriate config file that contains the deployment parameters.

At a time T4, autonomous vehicle 1201 may drive on the road that was characterized at time T2. Autonomous vehicle 1201 adjusts deployment parameters associated with a rapid deceleration system at a time T5. The adjustments may be made based on the road characterization data to substantially enable autonomous vehicle 1201 to efficiently deploy an anchor of a rapid deceleration system.

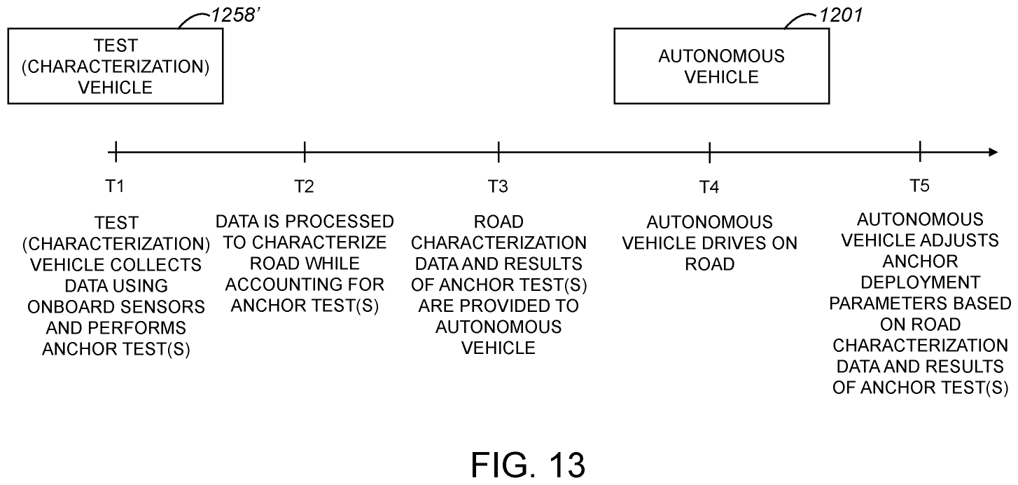

As discussed above with respect to FIG. 6, a test vehicle may include the capability to perform an anchor or road test. That is, a test vehicle may be arranged to deploy an anchor and to determine appropriate parameters relating to the deployment of the anchor into a particular road surface. FIG. 13 is a diagrammatic representation of a process, over time, of obtaining and utilizing road characterization data as well as data associated with an anchor or road test in accordance with an embodiment. At a time T1, a test or characterization vehicle 1258′ is drives or otherwise operating on a surface such as a road surface. While driving or otherwise operating, test vehicle 1258′ collects data using onboard sensors, and also performs one or more anchor tests. Performing one or more anchor tests may typically include deploying an anchor into a test surface, which may be a road surface, one or more times to determine an appropriate deployment force or pressure for the particular test surface.

At a time T2, the data obtained by test vehicle 1258′ at time T2 is processed to characterize the road while substantially accounting for the one or more anchor tests. Processing the data may further include processing supplemental data, such as data obtained from databases configured to store road information. The data may be processed by a simulation system such as simulation system 874 of FIG. 8 which effectively identifies appropriate deployment forces associated with a rapid deceleration system. The data may be processed onboard test vehicle 1258′, by a system that is remote with respect to test vehicle 1258′, and/or by both test vehicle 1258′ and a system that is remote with respect to test vehicle 1258′. Processing data generally include identifying deployment parameters for anchors of a rapid deceleration system that are suitable for efficiently deploying the anchors at particular locations on a road. The deployment parameters may be identified using a simulation system such as simulation system 874 in addition to, or in lieu of, using results of the one or more anchor tests. That is, the one or more anchor tests may be accounted for when data is processed.

After the data is processed, the data as well as the results of the one or more anchor tests may be provided at a time T3 to autonomous vehicle 1201 which may use the data to determine deployment parameters to use to deploy an anchor of a rapid deceleration system. At a time T4, autonomous vehicle 1201 may drive on the road that was characterized at time T2. Autonomous vehicle 1201 adjusts deployment parameters associated with a rapid deceleration system at a time T5. The adjustments may be made based on the road characterization data and the results of the one or more anchor tests to substantially enable autonomous vehicle 1201 to efficiently deploy an anchor of a rapid deceleration system.

Although only a few embodiments have been described in this disclosure, it should be understood that the disclosure may be embodied in many other specific forms without departing from the spirit or the scope of the present disclosure. By way of example, a rapid deceleration mechanism may include components configured to absorb energy. Such components may include, but are not limited to including, a back suspension system of a vehicle that may be crushed to absorb energy and/or a relatively high strength strap coupled to an anchor which may to crush the frame and/or suspension of the vehicle to absorb energy.

A rapid deceleration mechanism may be mounted on a vehicle, as for example to a bottom side of a chassis, using any suitable mechanism and/or method. For example, mechanical fasteners such as screws and/or bolts may be used to couple a housing of a rapid deceleration mechanism to a chassis of a vehicle.

A rapid deceleration mechanism may, in one embodiment, include multiple anchors. Different anchors may be deployed based on the type of road to which a vehicle is to be substantially anchored. For instance, a rapid deceleration mechanism may include anchors of different lengths and/or shapes, and the particular anchor or anchors deployed into a road surface may vary depending upon the characteristics of the road surface.

When characterizing a road, features on or in the road may be accounted for. By way of example, when a road includes a maintenance hole cover, the location of the maintenance hole cover as well as the material from which the maintenance hole cover is formed may be indicated. Because forces needed to deploy a rapid deceleration mechanism such an anchor into a maintenance hole cover may differ from forces needed to deploy an anchor into asphalt or concrete, the identification of a maintenance hole cover or other metal figures enables an anchor to be deployed using an appropriate amount of force.

When a road is covered, e.g., by a layer of ice or snow, providing forces sufficient to deploy a rapid deceleration mechanism may vary from when the road is not covered. For instance, when a road is covered by a relatively thick layer of ice, an anchor may effectively be anchored in the thick layer of ice rather than in the material that forms the road. Deploying an anchor into ice may be associated with different deployment parameters than are associated with deploying an anchor into a road. By way of example, the deployment of an anchor to penetrate a purely asphalt target may be associated with different deployment parameters than would be utilized for the deployment of an anchor to penetrate a target composed of a layer of ice on top of a layer of asphalt.

When deployment parameters are stored, e.g., in one or more config files on an autonomous vehicle or in one or more config files on a database that is accessible to the autonomous vehicle, the deployment parameters may effectively be searched when the autonomous vehicle is to activate a rapid deceleration system. In other words, a suitable config file that contains deployment parameters may be identified for use through searching through a multiple config files. Such a search may include, but is not limited to including, identifying a particular physical location and/or identifying one or more config files associated with the particular physical location. By way of example, when a rapid deceleration system is to be deployed at a particular location, the config files may be searched to identify one or more config files associated with the particular location, and the one or more config files may further be searched based on a time of day and/or a current temperature at the particular location to effectively identify the config file and, hence, the one or more deployment parameters, to use to deploy the rapid deceleration system.

As roads may change, deployment parameters associated with particular locations on the roads may be updated periodically. When a road is resurfaced, for instance, a test vehicle may drive over the resurfaced road to collect updated data, to cause updated deployment parameters to be generated, and to cause updated config files to be provided to a vehicle on which a rapid deceleration mechanism is mounted.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A method comprising:
determining that a rapid deceleration mechanism of a vehicle is to be deployed at a first location;
identifying at least one deployment parameter associated with a deployment of the rapid deceleration mechanism, the at least one deployment parameter being associated with the first location; and
deploying the rapid deceleration mechanism at the first location based on the at least one deployment parameter.

2. The method of claim 1 wherein the at least one deployment parameter includes at least one selected from a group including a deployment force and a deployment pressure.

3. The method of claim 1 wherein the first location is a location on a road, and wherein the at least one deployment parameter is a deployment force, the deployment force being specified based on a material from which the road is formed.

4. The method of claim 1 wherein the first location is a location on a road, and wherein identifying the at least one deployment parameter includes identifying a temperature at the first location.

5. The method of claim 4 wherein the at least one deployment parameter includes a deployment force for the rapid deceleration mechanism, the deployment force being specified based on the material and the temperature.

6. The method of claim 1 wherein the first location is a location on a road and the rapid deceleration mechanism includes an anchor and an energetics arrangement, and wherein deploying the rapid deceleration mechanism at the first location based on the at least one deployment parameter includes deploying the anchor into the road using the energetics arrangement.

7. The method of claim 6 wherein the at least one deployment parameter includes at least one selected from a group including a deployment force and a deployment pressure, and wherein deploying the rapid deceleration mechanism at the first location includes deploying the anchor using the energetics arrangement with the at least one selected from the group including the deployment force and the deployment pressure.

8. The method of claim 1 wherein the vehicle is an autonomous vehicle.

9. A vehicle comprising:
a chassis; and
a rapid deceleration system carried on the chassis, wherein the rapid deceleration system is configured to deploy an anchor to anchor the vehicle to a road surface, the rapid deceleration system further being configured to deploy the anchor at a first location based on at least one deployment parameter, the at least one deployment parameter including at least one selected from a group including a deployment force and a deployment pressure.

10. The vehicle of claim 9 wherein the first location is a first location on a road, the road being formed from a material, and wherein the at least one deployment parameter is a deployment force, the deployment force being specified based on the material.

11. The vehicle of claim 10 wherein the at least rapid deceleration system is configured to select the at least one deployment parameter from a plurality of deployment parameters, wherein selecting the at least one deployment parameter includes:
identifying a temperature at the first location, and
selecting the at least one deployment parameter based on the temperature.

12. The vehicle of claim 11 wherein the rapid deceleration system includes an anchor and an energetics arrangement, and wherein the at least one deployment parameter includes the deployment force, the deployment force further being specified based on the temperature.

13. The vehicle of claim 12 wherein the rapid deceleration system is configured to deploy the rapid deceleration mechanism at the first location based on the at least one deployment parameter is configured to deploy the anchor into the road using the energetics arrangement.

14. The vehicle of claim 9 wherein the vehicle is an autonomous vehicle.

15. A platform comprising:
a first vehicle, the first vehicle including a chassis and a rapid deceleration system carried on the chassis, the rapid deceleration system including an anchor, wherein the rapid deceleration system is configured to deploy the anchor to anchor the first vehicle to a road surface, the rapid deceleration system further being configured to deploy the anchor at a first location based on at least one deployment parameter, the at least one deployment parameter including at least one selected from a group including a deployment force and a deployment pressure; and
an apparatus, the apparatus including
a simulation system, the simulation system configured to determine at least one of the deployment force and the deployment pressure associated with the first location.

16. The platform of claim 15 wherein the first location is located on a, and wherein the apparatus further includes a second vehicle, the second vehicle configured to identify at least one characteristic of the road.

17. The platform of claim 16 wherein the at least one characteristic of the road includes at least one selected from a group including a composition of the road, a thickness of the road, and a temperature of the road.

18. The platform of claim 17 wherein the at least one characteristic of the road is provided to the simulation system, and wherein the simulation system is configured to determine the at least one of the deployment force and the deployment pressure using the at least one characteristic of the road.

19. The platform of claim 15 wherein the rapid deceleration system includes an energetics system, the energetics system configured to deploy the anchor with the at t least one selected from the group including the deployment force and the deployment pressure.

20. The platform of claim 15 wherein the first vehicle is an autonomous vehicle.
